(19) United States
(12) Patent Application Publication
(10) Pub. No.: US 2010/0264178 A1
(43) Pub. Date: Oct. 21, 2010

(54) Locking parking payment holder

(76) Inventor: Thomas J. DiVito, Southington, CT (US)

Correspondence Address: Thomas J. DiVito, 126 Roaring Brook Drive, Southington, CT, 06489, US

(21) Appl. No.: 12/386,483

(22) Filed: Apr. 20, 2009

(51) Int. Cl. B60R 7/00

(52) U.S. Cl. 224/277

(57) ABSTRACT

A parking payment holder device that is lockable to a parked vehicle so that evidence of proper payment is visible to parking enforcement personnel. The holder will have a center cavity with a minimum of one clear side, a through hole, and a locking means like cable lock or padlock to allow the holder to be secured to an open vehicle like a motorcycle or convertible.

### BACKGROUND OF INVENTION

1) Field of Invention

Parking meters are now being replaced or augmented by two parking payment technologies: Personal parking meters and Pay stations. Personal parking meters are credit card sized electronic devices that include a display screen and prepaid parking time. Buttons on the front of the device control the functions to start and stop the parking time as well as control the parking zone displayed on its screen. Pay stations are centrally located machines that collect money and issue a receipt for the parking paid, the location and the time remaining. Both the personal parking meter and the pay station receipt typically require their display on the dashboard of the vehicle so enforcement officers may verify the parking payment and correct location.

The present invention provides a method to secure a personal parking meter or other proof of parking payment to an open vehicle like motorcycle or convertible.

2) Description of the Prior Art

There currently is no device to secure a personal parking meter to an open vehicle. Parking payment receipts often have sticky backs so they can be attached so they do not blow away. However there is no way to prevent a passerby from taking the receipt for their own use.

### SUMMARY OF THE INVENTION

The present invention allows an open vehicle to display proof of paid parking in a secure and tamper resistant holder.

A locking holder in accordance with the present invention includes a hard-sided container with at least one clear side and is attachable to part of an open vehicle (like the handlebar or steering wheel) with a locking cable or padlock.

### BRIEF DESCRIPTION OF THE DRAWINGS

The present invention may be better understood as detailed in the description given here and by reference to the accompanying drawings in which:

FIG. 1 is a front view, the back being symmetrical;

FIG. 2 is a side view, both sides being symmetrical, of FIG. 1;

FIG. 3 is a top view of FIG. 1;

FIG. 4 is a bottom view of FIG. 1;

FIG. 5 is a perspective view from above and front in accordance with the present invention.

### DETAILED DESCRIPTION OF THE INVENTION

With reference to the drawings, a preferred embodiment of a Locking Parking Payment Holder in accordance with the present invention has been shown.

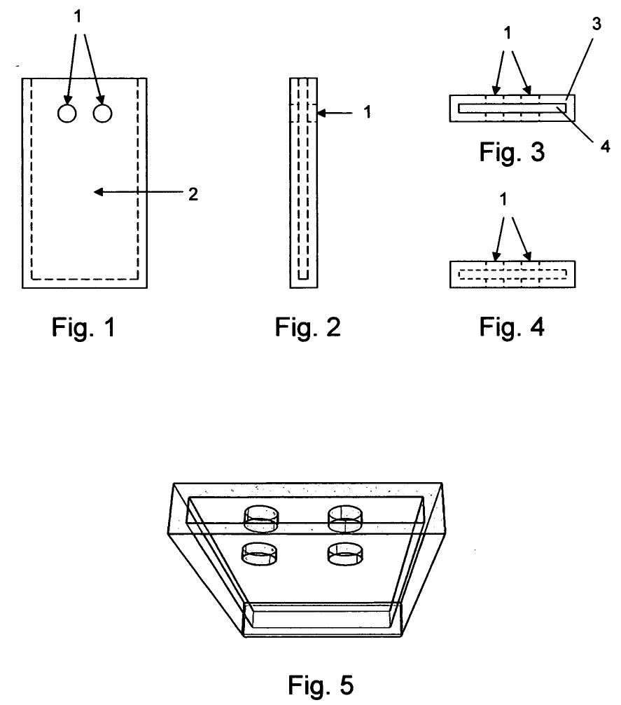

FIGS. 1-4 show a holder that is solid on the front, back, two sides, and bottom. The top is open to allow insertion of parking payment. Holes 1 are made near the top in the front and the back to accommodate the shackle of a padlock or wire of a cable lock. The shackle or cable will prevent unauthorized access to the holder contents and simultaneously secure the holder to the open vehicle.

FIG. 1 shows the front 2 of the holder is clear so the contents are visible from outside.

FIG. 3 illustrates that the walls 3 of the holder are of sufficient thickness to prevent compression of the front and back to allow access to the buttons of a personal parking meter.

FIG. 3 depicts an open center cavity 4 that will accommodate the parking payment.

Preferably, the holder is made of durable plastic that is clear or transparent so that the contents are visible from the outside.

What is claimed is:

1. A parking payment holder that attaches to an open vehicle (like convertible or motorcycle) with a cable lock or padlock.

2. A parking payment holder of claim 1, where the front is made from relatively clear or transparent plastic and is resistant to fading or yellowing from sun light.

3. A parking payment holder where the walls are of sufficient strength and thickness so the front and back cannot easily be compressed to allow access to the buttons on a personal parking meter.

4. A parking payment holder with an open top revealing access to the center cavity.

5. A parking payment holder having at least one through hole near the top of both the front and back to prevent access to the center cavity via blocking means of a detachable lock.

6. A parking payment holder of claim 5, where the through holes can alternative be placed on the sides of the holder.
